(19) United States
(12) Patent Application Publication
(10) Pub. No.: US 2022/0388809 A1
(43) Pub. Date: Dec. 8, 2022

(54) System and method for contactless provisioning of elevator service

(71) Applicant: Mirza Faizan, Irving, TX (US)

(72) Inventors: Mirza Faizan, Irving, TX (US); Mirza Rizwan, Patna (IN); Hamza Azeez, Plano, TX (US); Parth Behani, Bangalore (IN); Mollie Hamman, Dallas, TX (US); Taifur Rehman, Plano, TX (US); Ayushi Sinha, Plano, TX (US); Aaira Syed, Plainsboro, NJ (US); Mustafa Syed, Murphy, TX (US); Yaseen Syed, Murphy, TX (US)

(21) Appl. No.: 17/339,445

(22) Filed: Jun. 4, 2021

(51) Int. Cl. B66B 1/46; B66B 1/24

(52) U.S. Cl. CPC B66B 1/468; B66B 1/2408; B66B 13/146

(57) ABSTRACT

The number of bacteria present on an elevator button is almost 40 times higher than on a public toilet seat. An elevator that requires no physical contact is the answer. Just by the use of the mobile-phone, the transmission of diseases and viruses will be enormously reduced. The present invention discloses contactless method and system for provisioning elevator service from a source floor to a destination floor. The method comprising sensing a direction of a swiping action of a user. Thereafter determining the first direction that corresponds to an elevator upward direction or a second direction that corresponds to an elevator downward direction. Further, based on the determined said first direction or the second direction, the elevator is provisioned. After arrival of the elevator, a scan code is generated which is a destination code of said destination floor to which the user wishes to travels.

### TECHNICAL FIELD

The present invention generally relates to a system and a method for provisioning of an elevator service. More specifically, to a system and a method for contactless provisioning of an elevator service.

### BACKGROUND OF THE INVENTION

Due to surface contact, elevator buttons carry numerous infectious diseases that could be transmitted from person to person. Touchless elevator control allows the reduction of the spread of disease through touching infected surfaces. Presently, the COVID-19 has alarmed the world for the rapid spreading of virus, due to multiple touches of to public utilities and this has forced to the contactless operable utilities.

Patent (CN104495537) tried to make the elevators faster, smoother, and more reliable rather than trying to make it touchless. The elevator is moved to a floor by scanning a QR code containing identity information and floor information. This is applicable only to specific buildings and makes the QR code specific to each person not making it universal.

Patent (WO2014178790A1) trigger the elevator's control panel to the designated floor (one floor for each device) of the passenger once it has communicated with the mobile device's Bluetooth. Additionally the first selection floor system will be the first choice of which floor the passenger will want to go to, by default it is either the ground or first floor. This is not for the ease of use/comfort because the elevator cart will have to stop for every floor making it time consuming. This also have an optional password value which is set to trigger a certain lift with the same password. However, without the correct password the elevator auto selector/activator system will not be triggered. Thus, this application is not viable without a certain initiating call which will not be readily available to all passengers.

Thus, there is an unmet need for a system and a method for contactless provisioning of an elevator service.

### SUMMARY OF THE INVENTION

An embodiment is directed to a contactless method for provisioning elevator service from a source floor to a destination floor, the method comprising: sensing, by a plurality of sensors, a direction of a swiping action of an user; determining, by a gesture interface comprising the sensor, a first direction that corresponds to an elevator upward direction or a second direction that corresponds to an elevator downward direction; initiating, by a processor, a request for an elevator service, based on the determined said first direction or the second direction; generating, by an electronic device, a scan code, wherein the scan code is a destination code of said destination floor; determining, by said processor, a destination floor number from the generated scan code; and provisioning, by the processor, the elevator to the determined destination floor number.

In addition to one or more of the features described above or below, or as an alternative, identifying by the processor an elevator at a first location, wherein the first location is closest location from the source floor.

In addition to one or more of the features described above or below, or as an alternative, controlling by the processor a gate of the elevator.

In addition to one or more of the features described above or below, or as an alternative, detecting a face reading, by a face recognition detector, based on which the first direction or the second direction is determined.

In addition to one or more of the features described above or below, or as an alternative, determining the destination floor, by a gesture detector, based on body action of the user.

In addition to one or more of the features described above or below, or as an alternative, determining, by a facial recognition device, the destination floor based on face action of the user.

An embodiment is directed to a contactless system for provisioning elevator service from a source floor to a destination floor, the system comprising: a plurality of sensors configured to sense a direction of a swiping action of an user; a gesture interface unit configured to determine a first direction that corresponds to an elevator upward direction or a second direction that corresponds to an elevator downward direction; a memory unit; an electronic device configured to generate a scan code; and a processor configured to: initiate a request for an elevator service, based on the determined said first direction or the second direction; determine a destination floor number from the generated scan code; and provision said elevator to the determined destination floor number.

In addition to one or more of the features described above or below, or as an alternative, the electronic device is a QR code generating device.

In addition to one or more of the features described above or below, or as an alternative, comprising a gesture detector.

In addition to one or more of the features described above or below, or as an alternative, comprising a facial recognition device

In addition to one or more of the features described above or below, or as an alternative, comprising a light indicator, wherein the light indicator is configured to indicate arrival of the provisioned elevator.

An embodiment is directed to an apparatus comprising: at least one processor; and a memory having instructions stored thereon that, when executed by the at least one processor, cause the apparatus to: sense an input provided by a user; generate a scan code based on the input provided by the user; initiate a request for an elevator service, based on the generated scan code; determine a destination floor number from said generated scan code; and provision said elevator to said destination floor number based on the scan code.

In addition to one or more of the features described above or below, or as an alternative, wherein the instructions, when executed by said processor, cause the at least one door of said apparatus to be at least one of: closed, opened, and motion stopped.

### OBJECTIVE OF INVENTION

The objective of the disclosed invention is to provide a contactless method for provisioning elevator service from a source floor to a destination floor.

Yet another objective of the invention is to provide a contactless system for provisioning elevator service from a source floor to a destination floor.

Yet another objective of the present invention is to provide an apparatus for provisioning elevator service from a source floor to a destination floor.

Yet another objective of the present invention is to prevent the elevator buttons from caring numerous infectious diseases that may transmit from person to person.

Yet another objective of the invention is to provide a safe and secured elevator service to the users.

Yet another objective of the invention is to provide a QR based destination determination method to travel from one floor to another floor.

Yet another objective of the invention is to provide a contactless elevator calling method based on elevator preferences.

Yet another objective of the invention is to provide a safe elevator system.

Yet another objective of the invention is to provide an elevator system for disabled users.

### BRIEF DESCRIPTION OF THE DRAWINGS

The accompanying drawings illustrate various embodiments of systems, methodₛ, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a schematic block diagram illustrating an exemplary contactless system;

FIG. 2A illustrates an exemplary block diagram of a system for requesting elevator service in a given direction of travel based on a swiping action;

FIG. 2B illustrates an exemplary block diagram of a system for requesting elevator service in a given direction of travel based on another swiping action;

FIG. 3A is a flowchart illustrating an exemplary method operable by a user, outside the elevator, to provision elevator service;

FIG. 3B is a flowchart illustrating an exemplary method operable by a user, inside the elevator, to provision elevator service;

FIG. 4 is an exemplary functional flowchart for the contactless method for provisioning elevator service from a source floor to a destination floor.

### DETAILED DESCRIPTION OF DRAWINGS

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device that includes one or more processors/microcontrollers and/or any other electronic components, or a device or a system that performs one or more operations according to one or more programming instructions/codes. Examples of a computing device may include, but are not limited to, a desktop computer, a laptop, a personal digital assistant (PDA), a mobile device, a smartphone, a tablet computer (e.g., iPad®, and Samsung Galaxy Tab®), and the like.

An “elevator” refers to a vertical transport vehicle that efficiently moves people or goods between floors of a building. Further, the elevators are powered by electric motors. In an embodiment of the present invention, the building may have plurality of elevators controlled by a single processor.

A “gesture interface” corresponds to a sensor that senses the gesture of the user and may generate a data. The gesture may be a user defined gestures, such as left-to-right sweeping motion, may be used to request that the elevator door open or a right-to-left sweeping motion, may be used to request that the elevator door close.

A “sensor” refers to a device that detects/measures events or changes in quantities and provides a corresponding output, generally as an electrical or optical signal. In the present invention, the sensors may be face detection sensors, touch sensors, eye scanners, finger print scanners, human presence detection sensors and the alike. The sensor may detect user inputs, such as a presence, location, direction of movement. Such detection may be made using capacitive, optical, or acoustic systems that sense or interact with the user inputs. The inputs may include a user's body or part of the user's body, or a device or artifact carried by the user. These examples are currently contemplated, but it should be understood that alternatives exist.

A “wearable device” refers to a device which may be easily worn by a user. The user may wear the wearable device at a plurality of body parts and not necessarily a wrist of the user. The wearable device may be utilized to generate a QR code.

A “source floor” may correspond to a floor from which the call for the elevator may be registered. In an embodiment of the present invention, the source floor may be an upper floor than the destination floor. In an exemplary embodiment, the source floor may correspond to floor number 2.

A “destination floor” may correspond to a floor for which the call for the elevator may be registered. In an embodiment of the present invention, the destination floor may be an upper floor than the source floor. In an exemplary embodiment, the source floor may correspond to floor number 6.

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

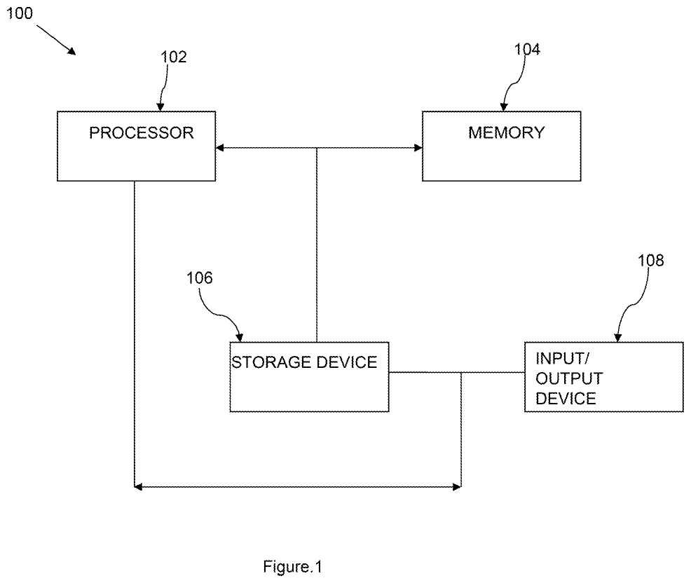

FIG. 1 is a schematic block diagram illustrating an exemplary contactless system;

FIG. 1 shows an example of a computing device 100 that can be used to implement the techniques described here. Computing device 100 is intended to represent various forms of digital computers, such as laptops, desktops, workstations, personal digital assistants, servers, blade servers, mainframes, and other appropriate computers. Computing device 100 is intended to represent various forms of mobile devices, such as personal digital assistants, cellular telephones, smartphones, and other similar computing devices. The components shown here, their connections and relationships, and their functions, are meant to be exemplary only, and are not meant to limit implementations described and/or claimed in this document.

Computing device 100 includes a processor 102, memory 104, a storage device 106, a high-speed interface connecting to memory and high-speed expansion ports, and a low speed interface connecting to low speed bus and storage device 106. Each of the components 102, 104, 106 are interconnected using various busses, and may be mounted on a common motherboard or in other manners as appropriate. The processor 102 can process instructions for execution within the computing device 100, including instructions stored in the memory 104 or on the storage device 106 to display graphical information for a GUI on an external input/output device, such as display coupled to high speed interface. In other implementations, multiple processors and/or multiple busses may be used, as appropriate, along with multiple memories and types of memory. Also, multiple computing devices 100 may be connected, with each device providing portions of the necessary operations (e.g., as a server bank, a group of blade servers, or a multi-processor system).

Processor 102 may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to a user. The control interface may receive commands from a user and convert them for submission to the processor 102. In addition, an external interface may be provided in communication with processor 102, so as to enable near area communication of device 100 with other devices. External interface may provide, for example, for wired communication in some implementations, or for wireless communication in other implementations, and multiple interfaces may also be used.

The computing device 100 is shown as including a memory 104. The memory 104 may store executable instructions. The executable instructions may be stored or organized in any manner and at any level of abstraction, such as in connection with one or more applications, processes, routines, procedures, methods, functions, etc.

In one implementation, the memory 104 is a volatile memory unit or units. In another implementation, the memory 104 is a non-volatile memory unit or units. The memory 104 may also be another form of computer-readable medium, such as a magnetic or optical disk. In one implementation, a computer program product is tangibly embodied in an information carrier. The computer program product contains instructions that, when executed, perform one or more methods, such as those described above. The information carrier is a computer- or machine-readable medium, such as the memory, expansion memory, or memory on processor.

Expansion memory may also be provided and connected to device 100 through expansion interface, which may include, for example, a SIMM (Single In Line Memory Module) card interface. Such expansion memory may provide extra storage space for device 100, or may also store applications or other information for device 200. Specifically, expansion memory may include instructions to carry out or supplement the processes described above, and may include secure information also. Thus, for example, expansion memory may be provide as a security module for device 100, and may be programmed with instructions that permit secure use of device 100. In addition, secure applications may be provided via the SIMM cards, along with additional information, such as placing identifying information on the SIMM card in a non-hackable manner.

The instructions stored in the memory 104 may be executed by one or more processors, such as a processor 102. The processor 102 may be coupled to one or more input/output (I/O) devices 108.

The storage device 106 is capable of providing mass storage for the computing device 100. In one implementation, the storage device 106 may be or contain a computer-readable medium, such as a floppy disk device, a hard disk device, an optical disk device, a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 104, the storage device 106, or memory on processor 102.

In some embodiments, the I/O device(s) 108 may include one or more of a keyboard or keypad, a touchscreen or touch panel, a display screen, a microphone, a speaker, a mouse, a button, a remote control, a joystick, a printer, a telephone or mobile device (e.g., a smartphone), a sensor, etc. The I/O device(s) 108 may be configured to provide an interface to allow a user to interact with the computing device or system 100.

The high-speed controller manages bandwidth-intensive operations for the computing device 100, while the low speed controller manages lower bandwidth-intensive operations. Such allocation of functions is exemplary only. In one implementation, the high-speed controller is coupled to memory 104, display (e.g., through a graphics processor or accelerator), and to high-speed expansion ports, which may accept various expansion cards (not shown). In the implementation, low-speed controller is coupled to storage device 106 and low-speed expansion port. The low-speed expansion port, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The memory 104 may store data 110. The data 110 may include data provided by one or more sensors. The data 110 may be processed by the processor 102 to control one or more parameters associated with a conveyance device. The data 110 may pertain to gesture data. In an alternate embodiment, the data 110 may pertain to frequent usage of elevator by a user. For example, the data 110 may include data indicative of an environment or scene captured by one or more sensors, including gesture data that may be included in the environment/scene. The data 110 may include a library of gestures that may be compared to the captured data for purposes of recognizing gestures or discriminating between gestures.

The computing device 100 may communicate wirelessly through communication interface, which may include digital signal processing circuitry where necessary. Communication interface may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, Wi-Fi, or other such transceiver (not shown). In addition, GPS (Global Positioning System) receiver module may provide additional navigation- and location-related wireless data to device 100, which may be used as appropriate by applications running on device 100.

Device 100 may also communicate audibly using audio codec, which may receive spoken information from a user and convert it to usable digital information. Audio codec may likewise generate audible sound for a user, such as through a speaker, e.g., in a handset of device 100. Such sound may include sound from voice telephone calls, may include recorded sound (e.g., voice messages, music files, etc.) and may also include sound generated by applications operating on device 100.

The system 100 is illustrative. In some embodiments, one or more of the entities may be optional. In some embodiments, additional entities not shown may be included. For example, in some embodiments the system 100 may be associated with one or more networks. In some embodiments, the entities may be arranged or organized in a manner different from what is shown in FIG. 1.

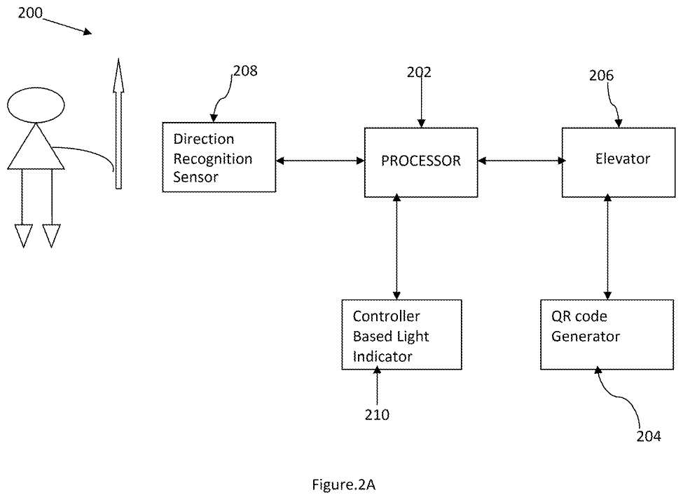

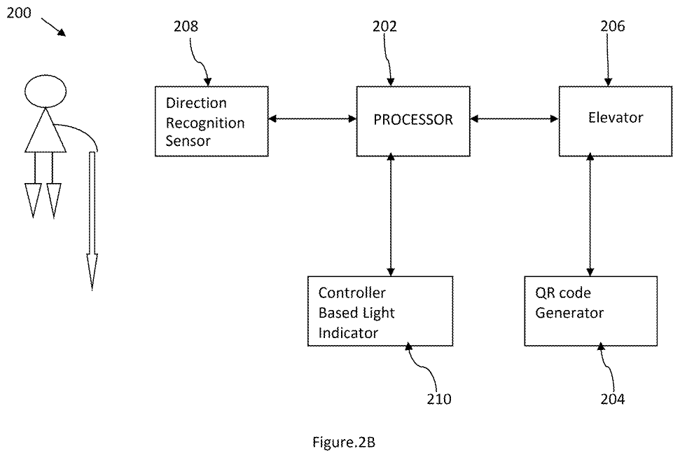

FIG. 2A illustrates an exemplary block diagram of a system for requesting elevator service in a given direction of travel based on a swiping action.

Referring to FIG. 2A, an exemplary block diagram of a system for requesting elevator service in a given direction of travel based on a swiping action is shown. The system 200 recognizes the swiping action of the user in front of sensors. The sensor may correspond to a direction recognition sensor 208 which may determine the direction indicated by the user. In this particular example, the swiping action may correspond to an upward direction indicated by the user.

In this exemplary embodiment, the user does an upward direction swiping action, based on which the processor may execute the instructions that may determine the nearby elevator 206 (elevator at first location) from the plurality of elevators, from the source location. Upon determination of the nearest elevator, the controller based light indicator 210 located in the panel at the source location floor indicates the arrival of the elevator which may be ready to take the user in the upward direction. Once arrived at the source floor, the doors of the elevator based on the sensors determine the presence of the user, and henceforth remain open till the disappearance of the user's presence in front of the sensor. Furthermore, this request data is also stored in the memory.

Thereafter, the user after entering into the elevator may generate a QR code by QR code generator 204. The generated QR code may be the code of the source floor, which necessarily based on this example, will be a code of the upper direction floor as the user has made the request for moving the elevator to the upward direction. In an embodiment, the user may utilize mobile device or any other electronic device to generate the QR code.

Lastly, the processor 202 may generate the instructions to move the elevator to the destination floor based on the determined destination floor number indicated by the QR code. In an embodiment, the inner panel of the elevator may also include a QR code reader.

In an alternate embodiment, the direction of the elevator may be altered based on the generated QR code, which may correspond to either a lower floor or an upper floor from the source floor.

In an alternate embodiment, the user may rather than generating a QR code may show a numeric digits displayed on an electronic device to the floor number reader which may be presented inside the elevator. In an embodiment, the processor 102 may have numbers stored in the memory, which may be triggered when the user shows the same number on the electronic device.

In an alternate embodiment, the sensor outputs coordinates (e.g., two dimensional or three dimensional spatial coordinates) which may be processed by a processor (e.g., FPGA, microprocessor, controller, etc.) in communication with other assembly to recognize the user swiping action. The processor may be located in the sensor interface or at a distant location which may be remotely connected.

In an alternate embodiment, the system may detect a face expression of the user in front of sensors. The sensors may correspond to a face expression recognition sensor which may recognize the face expression of the user indicating the direction. In this particular example, the face expression of the user may correspond to an upward direction. Furthermore, in an embodiment, the eye of the user may also be utilized for determining the travel of direction of the user.

In an embodiment of the present invention, the sensor may be located in proximity to the door of the elevator.

In an alternate embodiment, the sensors may be located in a central module, from where the multiple elevators may be controlled.

FIG. 2B illustrates an exemplary block diagram of a system for requesting elevator service in a given direction of travel based on another swiping action;

Referring to FIG. 2B, an exemplary block diagram of a system for requesting elevator service in a given direction of travel based on a swiping action is shown. The system 200 recognizes the swiping action of the user in front of sensors. The sensor may correspond to a direction recognition sensor 208 which may determine the direction indicated by the user. In this particular example, the swiping action may correspond to a downward direction indicated by the user.

In this exemplary embodiment, the user does a downward direction swiping action, based on which the processor 202 may execute the instructions that may determine the nearby elevator 206 (elevator at first location) from the plurality of elevators, from the source location. Upon determination of the nearest elevator, the controller based light indicator 210 located in the panel at the source location floor indicates the arrival of the elevator which may be ready to take the user in the downward direction. Once arrived at the source floor, the doors of the elevator based on the sensors determine the presence of the user, and henceforth remain open till the disappearance of the user's presence in front of the sensor. Furthermore, this request data is also stored in the memory.

Thereafter, the user after entering into the elevator may generate a QR code by QR code generator 204. The generated QR code may be the code of the source floor, which necessarily based on this example, will be a code of the downward direction floor as the user has made the request for moving the elevator to the downward direction. In an embodiment, the user may utilize mobile device or any other electronic device to generate the QR code.

Lastly, the processor 202 may generate the instructions to move the elevator to the destination floor based on the determined destination floor number indicated by the QR code. In an embodiment, the inner panel of the elevator may also include a QR code reader.

In an alternate embodiment, the direction of the elevator may be altered based on the generated QR code, which may correspond to either a lower floor or an upper floor from the source floor.

In an alternate embodiment, the user may rather than generating a QR code may show a numeric digits displayed on an electronic device to the floor number reader which may be presented inside the elevator. In an embodiment, the processor 102 may have numbers stored in the memory, which may be triggered when the user shows the same number on the electronic device.

In an alternate embodiment, the sensor outputs coordinates (e.g., two dimensional or three dimensional spatial coordinates) which may be processed by a processor (e.g., FPGA, microprocessor, controller, etc.) in communication with other assembly to recognize the user swiping action. The processor 102 may be located in the sensor interface or at a distant location which may be remotely connected.

In an alternate embodiment, the system may detect a face expression of the user in front of sensors. The sensors may correspond to a face expression recognition sensor which may recognize the face expression of the user indicating the direction. In this particular example, the face expression of the user may correspond to a downward direction.

In an alternate embodiment, the user may generate a QR code by an electronic device, such as but not limited to, a hand handled device. Thereby at an instance when the QR code is generated, the same may be simultaneously communicated to the processor 102 of the elevator. The processor 102 upon receiving the QR code determines the source floor number from where the user has generated the request and the destination floor number. Thereafter, upon determination, the elevator proceeds to that source place from where the request has been initiated.

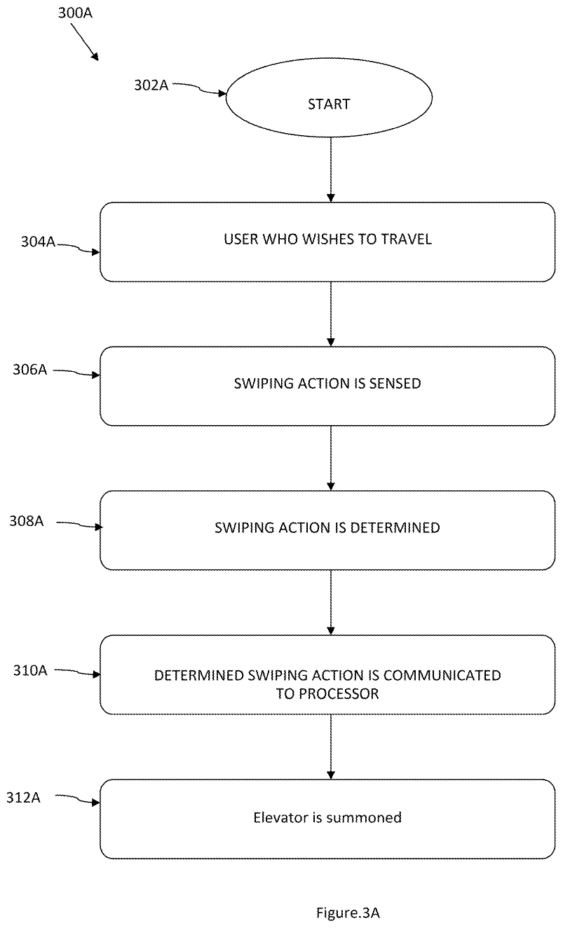

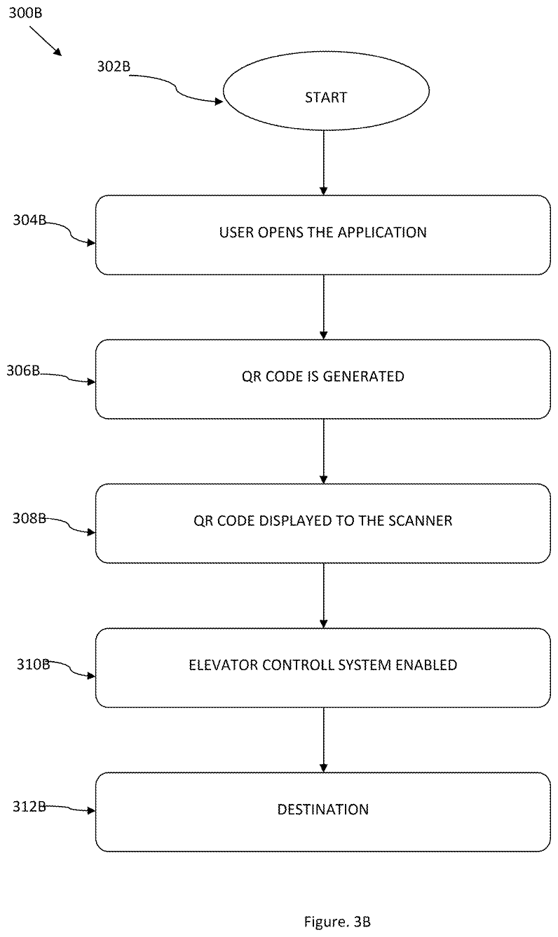

FIG. 3A is a flowchart illustrating an exemplary method operable by a user, outside the elevator, to provision elevator service, in accordance with at least one embodiment. With reference to FIG. 3A, there is shown a flowchart 300A that is described in conjunction with FIG. 1, FIGS. 2A and 2B. The method starts at step 302A and proceeds to step 304A.

At step 304A, a user wishes to travel in an elevator. In an embodiment, the user may walk till the panel of the elevators. In an alternate embodiment, the user may stand at a distant place to initiate the provisioning of the elevator service. The step jump at step 306A.

At step 306A, a swiping action of the user is sensed. The plurality of sensors placed at the console of the elevator panel outside the elevator car senses the swiping action of the user. In an embodiment of the present invention, the processor 102 may be configured along with the plurality of sensors.

At step 308A, the swiping action of the user is determined. The gesture interface determines a first direction or a second direction. The first direction may correspond to an elevator upward direction and the second direction may correspond to an elevator downward direction. In an embodiment of the present invention, the gesture interface may include the sensors that may determine the first direction or the second direction based on the sensed swiping action of the user. In an embodiment, the determined swiping action of the user may be stored in the memory 104 of the storage device 106 in the form of data 110.

In an alternate embodiment, the user's eye may be utilized in place of the swiping action, which may correspond to the direction of the travel of the user's interest.

At step 310A, the determined swiping action is communicated to the processor. The processor of the elevator initiates the movement of the elevator in the direction of the request. In an embodiment of the present invention, the processor 102 may be configured to determine the nearest elevator from the source location from which the user wishes to travel to the destination floor. Upon identification by the processor of the nearest elevator, the elevator initiates to travel in the direction of the floor from where the request may be generated.

At step 312A, identified elevator is summoned for the use by the user and the doors are opened. The processor 102 is configured to open the doors of the elevator, once the elevator arrives at the source floor. Furthermore, in an embodiment, if the door sensor does not found any human activity from a pre-determined time, then the door closes automatically and the elevator proceeds for serving the other request.

FIG. 3B is a flowchart illustrating an exemplary method operable by a user, inside the elevator, to provision elevator service, in accordance with at least one embodiment. With reference to FIG. 3B, there is shown a flowchart 300B that is described in conjunction with FIG. 1, FIGS. 2A, 2B, and 3A. The method starts at step 302B and proceeds to step 304B.

At step 304B, a user opens an application. An electronic device of the user is configured for enabling the functionality of the application. In an embodiment of the present invention, the elevator may include a console that may be configured to automatically generate a QR code when the user enters the elevator and the door gets closes.

At step 306B the generated QR code and at step 308B the generated QR code is displayed to the scanner. The QR code scanner inside the elevator is configured to read the generated QR code. In an embodiment of the present invention, the QR code reader in the elevator may be an integrated part of the inner console of the elevator or may be an attached part as an external assembly communicatively coupled with the processor of the elevator, which may when powered, reads the QR code, and thereafter prompts the processor 102 to process the code to determine the floor number of the destination floor.

At step 310B the elevator control system is enabled. The elevator control system performs the check with the security systems prior to carrying out the elevator service for the users, who may have requested to travel from the source floor to the destination floor.

At this stage, if the elevator is provisioned for multiple users. Then the processor 102 processes the floor sequence as per the pre-stored instructions, and thereby opens and closes the door of the elevator for the predetermined time and moreover based on the sensor's output determining the presence of the user in front of the gate. The process ends at step 312B.

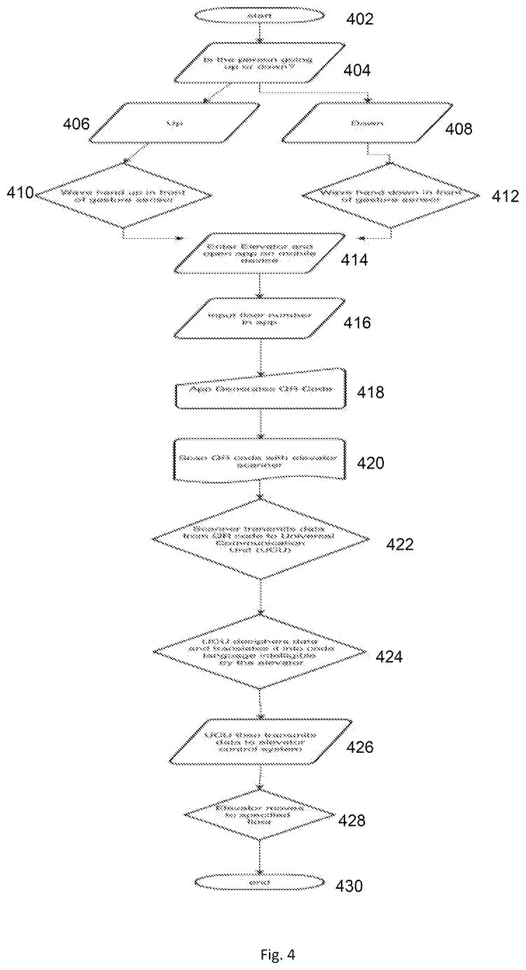

FIG. 4 is an exemplary functional flowchart for the contactless method for provisioning elevator service from a source floor to a destination floor.

In an exemplary embodiment shown in flow diagram from steps 402, 404, 406, 410, 414-430, a user wishes to travel in an upward direction in the elevator. The user may walk till the panel of the elevators. In an alternate embodiment, the user may stand at a distant place to initiate the provisioning of the elevator service. Thereafter, a swiping action of the user is sensed. The plurality of sensors placed at the console of the elevator panel outside the elevator car senses the swiping action of the user (up direction). After that, the swiping action of the user is determined (that the user wishes to travel in the upward direction) by the gesture interface. The determined swiping action of the user may be stored in the memory 104 of the storage device 106 in the form of data 110. Then, the determined swiping action is communicated to the processor. The processor of the elevator initiates the movement of the elevator in the direction of the request (upward direction). In this, the processor 102 determines the nearest elevator from the source location from which the user wishes to travel to the destination floor. Upon identification by the processor of the nearest elevator, the elevator initiates to travel in the direction of the floor from where the request may be generated. Thereafter, the identified elevator is summoned for the use by the user and the doors are opened.

After the elevator is arrived, the user enters the elevator and generates a QR code, which is the QR code of the destination floor (upper floor). After that, the users show the generated QR code to the QR reader in the inner panel of the elevator. Upon this, the processor determines the destination floor number, and the elevator is moved in the direction of the destination floor.

In an exemplary embodiment shown in flow diagram from steps 402, 404, 408, 412, 414-430, a user wishes to travel in a downward direction in the elevator. The user may walk till the panel of the elevators. In an alternate embodiment, the user may stand at a distant place to initiate the provisioning of the elevator service. Thereafter, a swiping action of the user is sensed. The plurality of sensors placed at the console of the elevator panel outside the elevator car senses the swiping action of the user (downward direction). After that, the swiping action of the user is determined (that the user wishes to travel in the downward direction) by the gesture interface. The determined swiping action of the user may be stored in the memory 104 of the storage device 106 in the form of data 110. Then, the determined swiping action is communicated to the processor. The processor of the elevator initiates the movement of the elevator in the direction of the request (downward direction). In this, the processor 102 determines the nearest elevator from the source location from which the user wishes to travel to the destination floor. Upon identification by the processor of the nearest elevator, the elevator initiates to travel in the direction of the floor from where the request may be generated. Thereafter, the identified elevator is summoned for the use by the user and the doors are opened.

After the elevator is arrived, the user enters the elevator and generates a QR code, which is the QR code of the destination floor (downward floor). After that, the users show the generated QR code to the QR reader in the inner panel of the elevator. Upon this, the processor determines the destination floor number, and the elevator is moved in the direction of the destination floor.

In an exemplary embodiment, the user wishes to travel from the source floor “2” to the destination floor “6”. In this scenario, presently, there are 3 elevators available for movement of the users. The processor senses the swiping action of the user (which is in travel request for the upward direction). The plurality of sensors placed at the console (“at floor 2”) of the elevator panel outside the elevator car senses the swiping action of the user (up direction). After that, the swiping action of the user is determined (that the user wishes to travel in the upward direction “to floor 6”) by the gesture interface. The determined swiping action of the user may be stored in the memory 104 of the storage device 106 in the form of data 110. Then, the determined swiping action is communicated to the processor. The processor checks where the elevators are and identifies the nearest elevator from the 3 elevators standing at floors 1, 5, and 8. The processor of the elevator initiates the movement of the elevator in the direction of the request (“say from floor 1 to floor 2”). In this, the processor 102 determines the nearest elevator (standing at floor 1) from the source floor (“2”) from which the user wishes to travel to the destination floor (“6”). Upon identification by the processor of the nearest elevator (“standing at floor 1”), the elevator initiates to travel in the direction of the floor from where the request (floor 2) may be generated. Thereafter, the identified elevator (which was standing at floor 1) is summoned for the use by the user and the doors are opened (when it reaches to source floor).

After the elevator is arrived, the user enters the elevator and generates a QR code, which is the QR code of the destination floor (“floor 6”). After that, the users show the generated QR code to the QR reader in the inner panel of the elevator. Upon this, the processor determines the destination floor number (“floor 6”), and the elevator is moved in the direction of the destination floor and the doors are opened upon reaching the destination floor (“floor 6”).

In another exemplary embodiment, the user wishes to travel from the source floor “6” to the destination floor “2”. In this scenario, presently, there are 5 elevators available for movement of the users. The processor senses the swiping action of the user (which is in travel request for the downward direction from floor 6 to floor 2). The plurality of sensors placed at the console (“at floor 6”) of the elevator panel outside the elevator car senses the swiping action of the user (down direction). After that, the swiping action of the user is determined (that the user wishes to travel in the downward direction “to floor 2”) by the gesture interface. The determined swiping action of the user may be stored in the memory 104 of the storage device 106 in the form of data 110. Then, the determined swiping action is communicated to the processor. The processor checks where the elevators are and identifies the nearest elevator from the 5 elevators standing at floors 1, 3, 4, 5, and 8. The processors determines that the request is from floor 6 and the nearest vacant elevator is at floor 8. The processor of the elevator initiates the movement of the elevator in the direction of the request (“say from floor 8 to floor 6”). In this, the processor 102 determines the nearest elevator (standing at floor 8) from the source floor (“6”) from which the user wishes to travel to the destination floor (“2”). Upon identification by the processor of the nearest elevator (“standing at floor 8”), the elevator initiates to travel in the direction of the floor from where the request (floor 6) may be generated. Thereafter, the identified elevator (which was standing at floor 8) is summoned for the use by the user and the doors are opened (when it reaches to source floor, i.e floor 6).

After the elevator is arrived, the user enters the elevator and generates a QR code, which is the QR code of the destination floor (“floor 2”). After that, the users show the generated QR code to the QR reader in the inner panel of the elevator. Upon this, the processor determines the destination floor number (“floor 2”), and the elevator is moved in the direction of the destination floor and the doors are opened upon reaching the destination floor (“floor 2”).

In a further exemplary embodiment, the user may be wearing a code generator portable device. This device may be configured to generate the code which may indicate the destination floor.

In a further exemplary embodiment, the destination floor may be identified by the facial expression of the user. To enable this, the elevator may be embedded with the face recognition device, which recognizes the expression of the face of the user, which shows the travel direction of the user's interest.

In a further embodiment, the elevator panels may also have light reflectors and indicators, which may be configured to indicate the arrival and the departure of the elevator. Based on this, the user may also gets notified about the arrival and the departure of particular elevator.

In a further exemplary embodiment, the user once enters the elevator may use voice enabled systems to perform the disclosed method. This ensures security in personalized based elevators as the voice of users, which are frequent and registered users is stored in the memory of the module. Which when matched, generates a QR code, and thereafter the elevator moves to the destination floor.

In a further exemplary embodiment, the user's phone by using the communication system may be so enabled that as soon as the user generates the code, and scans the code. Then the same identified floor number based on the generated code, may also gets communicated to the emergency contacts of the user. This may be advantageous for the child safety.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures may not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A contactless method for provisioning elevator service from a source floor to a destination floor, said method comprising:
sensing, by a plurality of sensors, a direction of a swiping action of an user;
determining, by a gesture interface comprising the sensor, a first direction that corresponds to an elevator upward direction or a second direction that corresponds to an elevator downward direction;
initiating, by a processor, a request for an elevator service, based on the determined said first direction or said second direction;
generating, by an electronic device, a scan code, wherein said scan code is a destination code of said destination floor;
determining, by said processor, a destination floor number from said generated scan code; and
provisioning, by said processor, said elevator to said determined destination floor number.

2. The contactless method for provisioning elevator service from a source floor to a destination floor as claimed in claim 1, further comprising identifying by said processor an elevator at a first location, wherein said first location is closest location from said source floor.

3. The contactless method for provisioning elevator service from a source floor to a destination floor as claimed in claim 1, further comprising controlling by said processor a gate of said elevator.

4. The contactless method for provisioning elevator service from a source floor to a destination floor as claimed in claim 1, further comprising detecting a face reading, by a face recognition detector, based on which said first direction or said second direction is determined.

5. The contactless method for provisioning elevator service from a source floor to a destination floor as claimed in claim 1, further comprising determining said destination floor, by a gesture detector, based on body action of said user.

6. The contactless method for provisioning elevator service from a source floor to a destination floor as claimed in claim 1, further comprising determining, by a facial recognition device, said destination floor based on face action of said user.

7. A contactless system for provisioning elevator service from a source floor to a destination floor, said system comprising:
a plurality of sensors configured to sense a direction of a swiping action of an user;
a gesture interface unit configured to determine a first direction that corresponds to an elevator upward direction or a second direction that corresponds to an elevator downward direction;
a memory unit;
an electronic device configured to generate a scan code; and
a processor configured to:
initiate a request for an elevator service, based on the determined said first direction or said second direction;
determine a destination floor number from said generated scan code; and
provision said elevator to said determined destination floor number.

8. The contactless system for provisioning elevator service from a source floor to a destination floor as claimed in claim 7, wherein said electronic device is a QR code generating device.

9. The contactless system for provisioning elevator service from a source floor to a destination floor as claimed in claim 7, further comprising a gesture detector.

10. The contactless system for provisioning elevator service from a source floor to a destination floor as claimed in claim 7, further comprising a facial recognition device.

11. The contactless system for provisioning elevator service from a source floor to a destination floor as claimed in claim 7, further comprising a light indicator, wherein said light indicator is configured to indicate arrival of said provisioned elevator.

12. An apparatus comprising:
at least one processor; and
a memory having instructions stored thereon that, when executed by the at least one processor, cause the apparatus to:
sense an input provided by a user;
generate a scan code based on the input provided by the user;
initiate a request for an elevator service, based on the generated scan code;
determine a destination floor number from said generated scan code; and
provision said elevator to said destination floor number based on the scan code.

13. The apparatus as claimed in claim 12, wherein the instructions, when executed by said processor, cause the at least one door of said apparatus to be at least one of: closed, opened, and motion stopped.
